(19) United States
(12) Patent Application Publication
(10) Pub. No.: US 2026/0328500 A1
(43) Pub. Date: Oct. 22, 2026

(54) CONTROL SYSTEMS AND METHODS FOR SMART THERMOPLASTIC COMPOSITES

(71) Applicant: Indian Institute of Technology Bombay, Mumbai (IN)

(72) Inventors: Kushal Manoj Soni, Mumbai (IN); Arun G. Krishnan, Mumbai (IN); Rupesh Eknath Ghyar, Mumbai (IN)

(21) Appl. No.: 19/697,345

(22) Filed: Jun. 3, 2026

Related U.S. Application Data
(63) Continuation of application No. PCT/IN2024/052327, filed on Dec. 3, 2024.

(30) Foreign Application Priority Data
Dec. 3, 2023 (IN) 202321082173

(51) Int. Cl. F28F 21/06; F28F 27/00

(52) U.S. Cl. CPC F28F 21/067; F28F 27/00; F28F 2255/06

(57) ABSTRACT

Smart thermoplastic composites comprising: at least a thermoplastic component (12) having a first cross-sectional profile; at least a thermal component (14) having a second cross-sectional profile and interfacing with said thermoplastic component (12); wherein, the cross-sectional arrangement is such that, the thermal component (14) modified the thermal nature of the thermoplastic component in either its hot-active state or in its cold-active state ensuring that there is a pliable region of deformation within said thermoplastic component (12) by creating a controlled thermal gradient within a region or volume of interest in said thermoplastic component (12) by: increasing localised temperature, of said thermoplastic component (12), above its softening point but below its viscous temperature; and maintaining ambient temperature above its softening point and maintaining localised temperature below its softening point.

### RELATED APPLICATIONS

This application claims priority under 35 U.S.C. § 120 to, and is a continuation of, co-pending International Application PCT/IN2024/052325, filed Mar. 12, 2024 and designating the US, which claims priority to IN application Ser. No. 202321082175, filed Dec. 3, 2023, such IN Application also being claimed priority to under 35 U.S.C. § 119. These IN and International applications are incorporated by reference herein in their entireties.

### FIELD

This invention relates to the field of materials and electro-mechanics.

Particularly, this invention relates to the field of functional materials comprising combinatorial components comprising thermoplastic components and non-thermoplastic components.

More particularly, this invention relates to a deformable combinatorial material.

Specifically, this invention relates to control systems and methods for smart thermoplastic composites.

### BACKGROUND

In engineering, ‘deformation’ refers to change in size or shape of an object. Depending on type of material, size and geometry of the object, and forces applied, various types of deformation may result.

FIG. 1 illustrates a typical stress vs. strain diagram indicating various stages of deformation along with elastic region, plastic region, and fracture region.

In elastic deformation, the deformation is temporary that can be undone simply by removing applied force. This is self-reversing property of a material.

In plastic deformation, the deformation is not undone simply be removing applied force. Thermoplastics with high chain mobility have a rather large plastic deformation range. Temperature induced chain mobility is used in the proposed invention to attain a viscoelastic state that allows for manipulation of the loss and storage modulus of the thermoplastic component. This invention relates to increasing the temperature of thermoplastics in “colder” ambient settings for desired deformation using non-thermoplastic thermal element(s), and inversely, in “hotter” ambient settings, thermal element is used to get the thermoplastic out of the viscoelastic state into a desired high stiffness state.

### SUMMARY

There is a need to invent materials with an extendable plastic deformation range.

There is a need for defining thermal element/s within a thermoplastic matrix for controlled thermal gradient in thermoplastic for achieving smart composites.

An object of the invention is to provide on-demand re-shapable materials.

Another object of the invention is to provide systems and methods for creating and controlling thermal gradient in thermoplastics/smart composites using a thermal component.

Yet another object of the invention is to provide control systems and methods for smart thermoplastic composites.

Still another object of the invention is to provide control systems and methods for creating and controlling thermal gradient in thermoplastics using a thermal component.

Another object of the invention is to establish a controlled thermal gradient between the thermal component and the surrounding ambient environment or entity.

According to this invention, there are provided control systems for smart thermoplastic composites comprising: a thermoplastic component having a first cross-sectional profile; a thermal component having a second cross-sectional profile and interfacing with said thermoplastic component; wherein, the cross-sectional arrangement is such that, the thermal component modifies the thermal nature of the thermoplastic component in either its hot-active state or in its cold-active state ensuring that there is a pliable region of deformation within said thermoplastic component by creating a controlled thermal gradient within a region or volume of interest in said thermoplastic component by: increasing localised temperature, of said thermoplastic component, above its softening point but below its viscous temperature; and maintaining ambient temperature above its softening point and maintaining localised temperature below its softening point; an energy source configured to enable transmission of energy between said thermal component and said thermoplastic component; and an energy sink configured to enable absorption of energy between said thermal component and said thermoplastic component; a control mechanism configured to achieve a pliable region of deformation, within said thermoplastic component, upon receipt of said transmitted energy, by creating a controlled thermal gradient within a region or volume of interest in said thermoplastic component, by establishing a controlled thermal gradient between said thermoplastic component and said thermal component such that heat flux between said energy source and said heat sink allows for a change in stiffness of the thermoplastic component: controlling said transmission of energy in a first chosen unidirectional manner and to control said absorption of energy in a second chosen unidirectional manner, each of said first chosen unidirectional manner and said second chosen unidirectional manner never being the same direction; controlling said transmission of energy between a viscous point of said thermoplastic component and a softening point of said thermoplastic component; modulation mechanisms configured to modulate energy vectors, in order to achieve controlled localised thermal differential, between at least one of: thermal link between said energy source and said thermoplastic component; thermal link between said energy source and said thermal component; thermal link between said energy sink and said thermoplastic component; thermal link between said energy sink and said thermal component; thermal link between said thermoplastic component and said thermal component; thermal link between said thermoplastic component and said ambient environment; and thermal link between said thermal component and said ambient environment.

wherein, temperature of said thermal component being such that difference between temperature of said thermoplastic component and surface temperature of said thermoplastic component for desired stiffness is minimized.

In at least an embodiment, said pliable region of deformation causing: thermo-softening of said smart composites in a cold surrounding; or thermo-hardening of said smart composites in hot surroundings.

In at least an embodiment, said modulation mechanisms being controlled by at least one of following parameters: surface area correlative to heat dissipation rate; total heat delivered correlated to heating rate; and degree of crystallinity.

In at least an embodiment, said modulation mechanisms comprising at least one of: a feedback control configured to modulate external energy vector with time to control energy output; a manual control configured such that the energy input can be controlled manually during operation of said thermoplastic-thermal component composite; a feedforward control configured such that said external energy vector is controlled by a deterministic logic or programming considering the desired application in the active and the inactive state of the thermoplastic-thermal component composite; and a timer with timed sequences for energy input based on known thermal inertia and response times of the thermoplastic-thermal component composite system.

In at least an embodiment, for said thermal component acting as an energy source, said control mechanism configured to achieve a pliable region of deformation, within said thermoplastic component, upon receipt of said transmitted energy, by creating a controlled thermal gradient within a region or volume of interest in said thermoplastic component, by: maintaining ratio (V_{E}) of loss modulus, of said thermoplastic component to storage modulus of said thermoplastic component be greater than or equal to 1.

In at least an embodiment, for said thermal component acting as an energy sink, said control mechanism configured to achieve a pliable region of deformation, within said thermoplastic component, upon receipt of said transmitted energy, by creating a controlled thermal gradient within a region or volume of interest in said thermoplastic component, by: maintaining ratio (V_{E}) of loss modulus, of said thermoplastic component to storage modulus of said thermoplastic component be lesser than 1.

In at least an embodiment, said control mechanism configured to achieve a pliable region of deformation, within said thermoplastic component, upon receipt of said transmitted energy, by creating a controlled thermal gradient within a region or volume of interest in said thermoplastic component, by: increasing localised temperature, of said thermoplastic component, above its softening point but below its viscous temperature; and maintaining ambient temperature above its softening point and maintaining localised temperature below its softening point.

In at least an embodiment, said interfacing is selected from a group of interfacing types selected from thermal interfacing, physical interfacing, partial interfacing, completely ensconced interfacing with the thermoplastic component completely ensconcing the thermal component, completely ensconced interfacing with the thermal component completely ensconcing the thermoplastic component, partially ensconced interfacing with the thermoplastic component partially ensconcing the thermal component, partially ensconced interfacing with the thermal component partially ensconcing the thermoplastic component.

In at least an embodiment, said transmission of energy and said absorption of energy being in the form of conduction, convection, and/or radiation.

In at least an embodiment, said control being selectable from a group of controls consisting of electrical control, pressure control, volume control, chemical control, electromagnetic irradiance control, mechanical force control, magnetic field control, flow rate control, acoustic heating control, and acoustic cooling control.

In at least an embodiment, said thermoplastic being activated in its hot active mode of working, in that, energy control, vide said control mechanism, from said energy source to said energy sink being controlled such that thermoplastic safety temperate (Tt) being more than thermoplastic viscous temperature (Tv/Tm) but being less than thermoplastic glass transition temperature (Tg).

In at least an embodiment, said thermoplastic being activated in its hot active mode of working, in that, energy control, vide said control mechanism, from said energy source to said energy sink being controlled such that temperature (Tsource) of said energy source being greater than or equal to temperature (Tth) of said thermal component, temperature (Tth) of said thermal component being greater than or equal to temperature (Ttp) of said thermoplastic component, temperature (Ttp) of said thermoplastic component being greater than or equal to temperature (Tsink) of said energy sink.

In at least an embodiment, said thermoplastic being activated in its cold active mode of working, in that, energy control, vide said control mechanism, from said energy sink to said energy source being controlled such that thermoplastic safety temperate (Tt) being more than thermoplastic glass transition temperature (Tg) but being less than thermoplastic viscous temperature (Tv/Tm).

In at least an embodiment, said thermoplastic being activated in its cold active mode of working, in that, energy control, vide said control mechanism, from said energy sink to said energy source being controlled such that temperature (Tsource) of said energy source being lesser than or equal to temperature (Tth) of said thermal component, temperature (Tth) of said thermal component being lesser than or equal to temperature (Ttp) of said thermoplastic component, temperature (Ttp) of said thermoplastic component being lesser than or equal to temperature (Tsink) of said energy sink.

In at least an embodiment, said thermal component, being a non-thermoplastic component, acting as an internal thermal source.

In at least an embodiment, said thermal component, being a non-thermoplastic component, composed of a polar compound or a dielectric material, when intercepted by electromagnetic radiation of corresponding frequency, acting as a heat source.

In at least an embodiment, said thermal component, being a non-thermoplastic component, which is in thermal contact with an external heat source and said thermoplastic component.

In at least an embodiment, for said thermal component acting as an energy source (16), said control mechanism configured to achieve a pliable region of deformation, within said thermoplastic component, upon receipt of said transmitted energy, by creating a controlled thermal gradient within a region or volume of interest in said thermoplastic component, by: maintaining ratio (V_{E}) of loss modulus, of said thermoplastic component to storage modulus of said thermoplastic component be greater than or equal to 1.

In at least an embodiment, for said thermal component acting as an energy sink, said control mechanism configured to achieve a pliable region of deformation, within said thermoplastic component, upon receipt of said transmitted energy, by creating a controlled thermal gradient within a region or volume of interest in said thermoplastic component, by: maintaining ratio (V_{E}) of loss modulus, of said thermoplastic component to storage modulus of said thermoplastic component be lesser than 1.

### BRIEF DESCRIPTION OF THE ACCOMPANYING DRAWINGS

FIG. 1 illustrates a typical stress vs. strain diagram indicating various stages of deformation along with elastic region, plastic region, and fracture region.

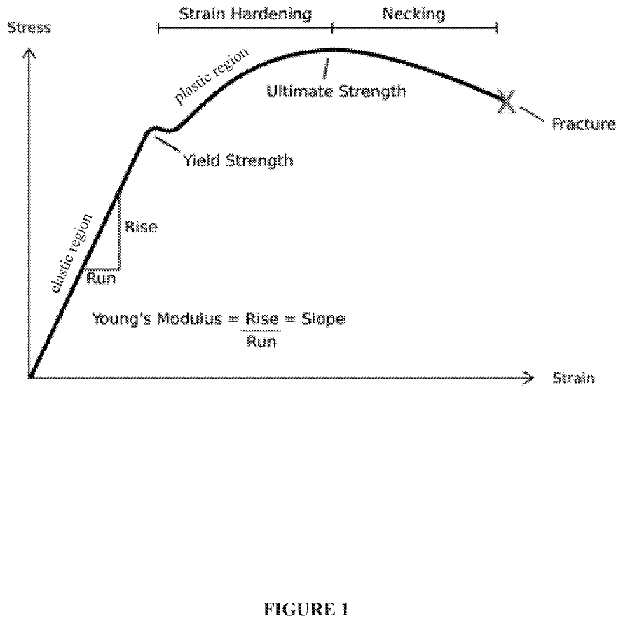

The invention will now be described in relation to the accompanying drawings, in which;

FIG. 2 illustrates a schematic block diagram for the smart thermoplastic composite of this invention;

FIG. 3 is an illustration showing an embodiment of the invention with a thermal component embedded inside a thermoplastic and an external energy source providing energy to the core which thereby causes change in the temperature of thermoplastic; and

FIG. 4 illustrates a schematic flow drawing for the control systems and methods for smart thermoplastic composites.

### DETAILED DESCRIPTION

According to this invention, there are provided smart thermoplastic composites.

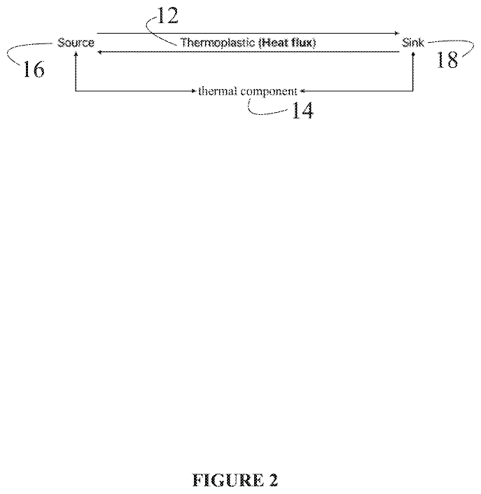

FIG. 2 illustrates a schematic block diagram for the smart thermoplastic composite of this invention.

In at least an embodiment, the present invention concerns a composite material or a combinatorial material, particularly being a smart composite, comprising at least a thermoplastic component (12) and at least a thermal component (14) coupled with the thermoplastic component (12). Additionally, the present invention concerns a composite material or a combinatorial material, particularly being a smart composite, comprising at least an energy source (16) and an energy sink (18).

For the purposes of this invention, viscous point of given thermoplastic is defined as a temperature at which the loss modulus of the thermoplastic is such that the displacement of the thermal element may occur due to the thermally induced viscosity in the thermoplastic. Whereas, the softening point of the given thermoplastic is defined as a temperature at which the loss modulus becomes equal to storage modulus, thereby becoming pliable. The ratio of loss modulus and storage modulus is defined as V_{E}.

The placement of the thermoplastic component (12) and the thermal component (14), with respect to each other, is such that thermal energy should be passed from one to the other in a bidirectional manner, the passing may be in the form of conduction, convection, and/or radiation.

The coupling between the thermoplastic component (12) and the thermal component (14) may be one of many configurations as seen in FIG. 5 of the accompanying drawings.

In at least an embodiment, as seen in FIG. 5a, of the accompanying drawings, the thermal component (14) is completely ensconced within the thermoplastic component (12).

In at least an embodiment, as seen in FIG. 5b, of the accompanying drawings, the thermal component (14) is partially ensconced within the thermoplastic component (12).

In at least an embodiment, as seen in FIG. 5c, of the accompanying drawings, the thermoplastic component (12) is partially ensconced within the thermal component (14).

In at least an embodiment, as seen in FIG. 5d, of the accompanying drawings, the thermoplastic component (12) is completely ensconced within the thermal component (14).

In at least an embodiment, the thermal component (14), being a non-thermoplastic component, acts as an internal thermal source that works on the basis of Ohmic heating (using a resistance wire) or Thermoelectric heating (using a Thermocouple). Electric current for the thermal element generates heat for these by eddy currents due to electromagnetic induction or electric current directly supplied to the conductor by conduction. This configuration facilitates ‘electric heating’.

In at least an embodiment, the thermal component (14), being a non-thermoplastic component, which can be composed of a polar compound or a dielectric material, when intercepted by electromagnetic radiation of the corresponding frequency, this acts as a heat source. One of the embodiments of this configuration can be a channel in the volume of the thermoplastic, filled with this thermal element. Another embodiment of the same can be a thermal component scattered throughout the volume of the thermoplastic in the form of a suspended additive. This configuration facilitates ‘heating by way of electromagnetic radiation and/or induction (near field)’

In at least an embodiment, the thermal component (14), being a non-thermoplastic component, which is in thermal contact with an external heat source and the thermoplastic. In such a configuration the thermal component acts as a conductor between a heat source by transferring the heat from the “hotter” external heat source to the thermoplastic in a “colder” ambient environment. Inversely, the thermal element may act as a conductor between a thermal sink in “hotter” ambient environment to increase the localised stiffness of the thermoplastic component. This configuration facilitates ‘contact heat transfer.’

In at least an embodiment, the source (16) passes energy to the thermal component.

In some embodiments, shape memory materials may be used, as a thermal component (15), that can apply a force on the thermoplastic component at particular temperatures and even be trained at other temperatures. Properties and characteristics of such materials need to be considered:
Martensitic Transformation Temperature
Austenitic Transformation Temperature
Hysteresis Width (ΔT)
Degree of Deformation
Programming temperature (Shape memory polymers)
Recovery temperature

Additionally, non-contact forces may also act on the composite, the non-contact forces being:
Gravity may be used to use the weight acting on the volume of interest in the embodiment;
Magnetic field acting on the volume of interest in the embodiment;
Static electric forces acting on the volume of interest in the embodiment.

In some embodiments, combination of externally acting contact forces may be used to deform or hold a form of the combined composite of this invention.

In some embodiments, combination of contact and non-contact forces may be used to deform or hold a form of the combined composite of this invention.

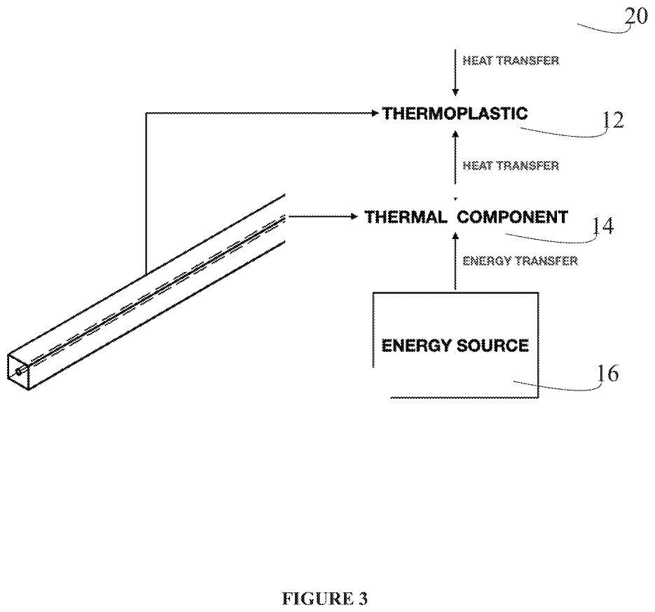

FIG. 3 is an illustration showing an embodiment of the invention with a thermal component embedded inside a thermoplastic and an external energy source providing energy to the core which thereby causes change in the temperature of thermoplastic

In its active state, the thermal component (14) either acts as a thermodynamic/energy sink (absorbing heat/energy) (18) or a thermodynamic/energy source (emitting heat/energy) (16), while its ambient environment (20)/entity becomes the opposite. The thermoplastic component (12) acts as a conductor/transmitter between them, facilitating transfer/transmission of heat between the thermal component (14) and the ambient environment (20), when there is a temperature difference between the two (14, 20).

The active state of this invention's smart composite material is characterized by application of an external energy vector to the thermal component (14), which creates a controlled thermal gradient within a region or volume of interest in the thermoplastic component (12). This gradient results in localized temperature changes, thereby allowing for a desired localised change in stiffness of the embodiment. The active state of the composite is defined as a state when an external energy vector acting on the thermal element (14) creates a controlled thermal gradient in the region/volume of interest of the thermoplastic component (12). There are two embodiments of this:
1. The localised temperature increases above the softening point but below a melting temperature of the thermoplastic (12).
2. The ambient temperature is above the Vicat softening point, and localised temperature is brought below by the thermal element (14).

Boundary conditions: At the interface between the thermal element and the thermoplastic, the temperature must reach the softening point at the farthest surface of the thermoplastic. The heat flux balance at this interface can be written as:

$$- {k}_{T} \frac{d T ( 0 )}{d x} = \frac{{Q}_{C}}{{A}_{C T}}$$

At the thermoplastic surface farthest from the thermal element:

$$- {k}_{T} \frac{d T ( {L}_{T P} )}{d x} = {h}_{inf} ( {T}_{S} - {T}_{inf} ) + ϵσ ( {T}_{S}^{4} + {T}_{inf}^{4} )$$

where Q_{C} is heat flow from the thermal element and A_{CT} is the contact area between the thermoplastic and the thermal element, ∈ is the emissivity of the thermoplastic surface, and σ is the Boltzmann constant, k_{T} is the thermal conductivity of the thermoplastic at the given temperature, h_{inf} is the heat transfer coefficient of the ambient environment, T_{inf} is the ambient temperature and T_{S} is the temperature for the corresponding desired V_{E}.

Upon transfer of energy to the non-thermoplastic component (14) from a source (16), there is rise in temperature of the non-thermoplastic component (14) above a threshold temperature. It thereby transfers heat to the thermoplastic component (12), allowing the thermoplastic component (12) to allow manipulated deformation, into a desired geometry upon application of force(s) or stress(es).

Subsequently, on discontinuation of energy supply to the thermal component (14), the embodiment of the composite is cooled down through active or passive means, allowing it to maintain its geometry.

Conversely, the thermal component (14) may be used to transfer heat out of the thermoplastic (12) using a heat sink (18) or a cooler to increase stiffness of the embodiment. This composite and combinatorial heat transfer method enables controlled deformation for various applications.

In at least an embodiment, the thermal component (14), being a non-thermoplastic component, is an energy source (16). The heat transfer from the thermal component (14) (non-thermoplastic component) to the thermoplastic component (12) is facilitated by conduction and/or convection and/or radiation. The heat flux, at the contact, or at the point of transfer, is such that the thermoplastic is not able to flow. The net heat flow through the thermoplastic is such that the surface temperature of the farthest surface from the thermal component (14) is adequate to change the loss modulus or storage modulus of the region [volume] of interest in the embodiment by at least 20%. Here, in its active state:
Thermal component (14) in the volume of the thermoplastic (12): The temperature distribution diverges from a unit of the thermal component (14) into a volume of interest in the thermoplastic (12);
Thermal component (14) outside the volume of the thermoplastic (12), both in a contact;
Thermal component (14) and the thermoplastic (12) have a surface contact.

In at least an embodiment, the thermal component (14), being a non-thermoplastic component, is an energy sink (18). The heat transfer to the thermal component [non-thermoplastic component] (14) from the thermoplastic component (12) is facilitated by conduction and/or convection and/or radiation. The heat flux, at the contact, or at the point of transfer, is such that the thermoplastic remains stiff due to cooling of the thermoplastic by the thermal component (14). The net heat flow through the thermoplastic is such that the surface temperature of the farthest surface from the thermal component (14) is adequate to maintain stiffness of the region [volume] of interest in the embodiment which is within 20% of the flexural stiffness of the thermoplastic when the polymer [chain] mobility is minimum. Here, in its active state:
Thermal component (14) in the volume of the thermoplastic (12): temperature distribution converges to a unit of the thermal component (14) into a volume of interest in the thermoplastic (12);
Thermal component (14) outside the volume of the thermoplastic (12), both in a contact;
Thermal component (14) and the thermoplastic (12) have a surface contact.

There could be one or more methods for varying temperature/s of the thermal component (14), the methods being selectable from:
Electric power: Control the electrical current, voltage to the non-thermoplastic component using resistive heating elements, thermoelectric devices, or other electrical heating/cooling mechanisms like Peltier cooling.
Pressure: Control the pressure in the system to change the temperature of the non-thermoplastic component through processes like compression or expansion.
Volume: Control the volume in the system to change the temperature of the non-thermoplastic component while holding the pressure constant.
Chemical Reactions: In thermo-chemical thermal component, control the rate and extent of chemical reactions in the thermal component to release or absorb heat.
Electromagnetic Irradiance: Control the exposure to radiation, intensity, luminosity with respect to the thermal component.
Mechanical Force: Controlling mechanical work, which can be converted into heat energy using friction or other processes.
Magnetic Field: In magnetic refrigeration or induction heating systems, control the magnetic field to manipulate the temperature of thermal component.
Flow Rate: Control the flow rate of a heat transfer fluid to vary the heat exchange with the non-thermoplastic component.
Acoustic heating/cooling: Control the amplitude, frequency of a thermoacoustic heat pump working on the thermal component.

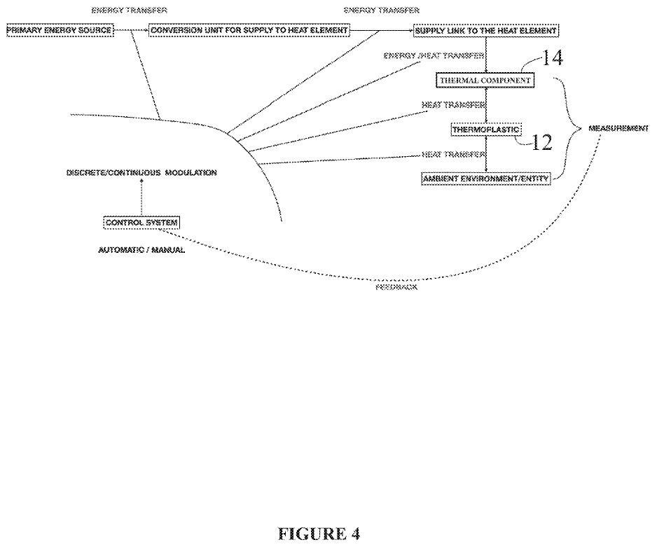

FIG. 4 illustrates a schematic flow drawing for the control systems and methods for smart thermoplastic composites.

The proposed invention is an energy control system designed for a thermal component (14) in a smart composite consisting of a thermoplastic component (12). This thermal component is arranged in conjunction with a thermoplastic component (12) to create a combined or composed embodiment; which is the smart composite of this invention. The primary goal of this invention is to establish a controlled thermal gradient between the thermal component (14) and surrounding ambient environment or entity such that heat flux between the source (16) and the sink (18) allows for a change in stiffness of the thermoplastic component (12). This thermal gradient is intended to enable thermal energy to flow between the thermal component (acting as either a source or a sink) and the environment, which, in turn, leads to a localised change in stiffness of the thermoplastic component (12). The control mechanism is to be used for achieving/maintaining a controlled thermal gradient in the region/volume of interest to achieve the desired stiffness change in the given ambient environment/entity.

The function of the control mechanism is to achieve and maintain a specific, controlled thermal gradient in the designated region or volume of interest of a combined entity comprising of a thermoplastic component (12) and a non-thermoplastic component (being the thermal component) (14) to allow: thermo-softening of the composite in a cold surrounding; or, conversely, thermo-hardening of the composite in hot surroundings; both, by virtue of heat sinking by the thermal component.

This is done by manual/automatic modulation of an energy vector between the following modules:

In at least an embodiment, there is a conversion unit for supplying energy to said thermal component: control of energy being converted from a primary energy source.

In at least an embodiment, there is a supply link for energy supply to the thermal component: control of energy heat transfer to the thermal component.

In at least an embodiment, there is a thermal component: control of heat transfer by modulating the thermal link between thermoplastic and thermal component.

In at least an embodiment, there is an ambient environment: control of ambient conditions and a thermal link between thermoplastic and the ambient entities.

In at least an embodiment, the primary energy source can be selected from a group of energy sources consisting of at least the following:
Electricity: facilitates control of electrical current and voltage
Pressure: facilitates regulation of system pressure
Volume: facilitates adjustment of system volume
Chemical Reactions: facilitates management of thermo-chemical reactions
Electromagnetic Irradiance: facilitates Control of Exposure and Intensity
Mechanical Force: facilitates regulation of mechanical work
Magnetic Field: facilitates manipulation of magnetic fields
Flow Rate: facilitates adjustment of heat transfer fluid flow
Acoustic Heating/Cooling: facilitates control of thermoacoustic heat pump

The following factors, must be considered, for energy supply and control:
Thermal conductivity of the thermoplastic
Maximum distance between the thermal source and sink
Heat deflection temperature
Specific heat capacity of the thermoplastic
Specific heat capacity of the thermal component
Heat rate between the thermoplastic and the ambient environment/entity(s)
Melting temperature of the thermoplastic, thermal component materials
Heat dissipation and absorption properties of the thermal component (e.g. resistance, conductivity)
Desired selective deformation and stiffening w.r.t space and time

In at least an embodiment, a plurality and combinations of these afore-mentioned modules may be used for the controlling/maintaining the temperature of the thermal component. This creates a controlled localised thermal differential between a surrounding environment of the composite and the thermal component of the composite; while maintaining integrity of the composite, without any undesired displacement of the thermal component with respect to the thermoplastic due to localised melting. This is followed by a desired change in stiffness due to a thermal gradient in the thermoplastic component of the composite within the given ambient environment or entity. The localised temperature in a given a thermal gradient in the thermoplastic should be below the melting temperature of the thermoplastic. Based on the embodiment of the composite, the function of the thermal component (thermal source or sink), arrangement of the thermal component with respect to the thermoplastic, thermal constraints of the desired application of the embodiment, structural requirements of the embodiment, desired deformation as a function of load, thermal conductivity of the materials, the nature of external energy source, and the energy transfer media.

In at least an embodiment, the control systems and methods, of this invention, comprises modulation mechanisms.

In at least an embodiment of the modulation mechanisms, there is provided a feedback control configured to modulate the external energy vector with time to control the heat output. Timed sequences for energy input based on known thermal inertia and response times of the thermoplastic-thermal component composite system are used for this.

In at least an embodiment of the modulation mechanisms, there is provided a manual control configured such that the energy input can be controlled manually based on observations or calculations during operation of the thermoplastic-thermal component composite.

In at least an embodiment of the modulation mechanisms, there is provided a feedforward control configured such that the external energy vector is controlled by a deterministic logic or programming considering the desired application in the active and the inactive state of the thermoplastic-thermal component composite. A plurality and combinations of these methods may be used for the controlling the energy vector acting on the thermal component.

The flexural, tensile, compressive moduli at the various temperature gradients in the thermoplastic may be determined using dynamic mechanical analysis of a given combination of the thermoplastic and the thermal component in a combined embodiment. This is to be used to map the stiffness of the combination of the thermal component and the thermoplastic as a function of thermal gradient. This is essential for building the control mechanisms, protocols, algorithms, open/closed loop systems.

In some embodiments, shape memory materials may be used, as a thermal component (14), that can apply a force on the thermoplastic component at particular temperatures and even be trained at other temperatures. Properties and characteristics of such materials need to be considered:
Martensitic Transformation Temperature
Austenitic Transformation Temperature
Hysteresis Width (ΔT)
Degree of Deformation
Programming temperature (Shape memory polymers)
Recovery temperature

Additionally, non-contact forces may also act on the composite, the non-contact forces being:
Gravity may be used to use the weight acting on the volume of interest in the composite;
Magnetic field acting on the composite;
Static electric forces acting on the composite.

In some embodiments, combination of externally acting contact forces may be used to deform or hold a form of the combined composite of this invention.

In some embodiments, combination of contact and non-contact forces may be used to deform or hold a form of the combined composite of this invention.

In terms of working of this invention's smart composite which exhibit self-deforming embodiments where deformation forces are applied intrinsically from the composite:

There are observed localised density changes:
Thermal Expansion: When a thermoplastic is heated, it generally undergoes thermal expansion, causing an increase in volume. Conversely, cooling tends to lead to thermal contraction and a decrease in volume;
Local Swelling: Depending on the thermoplastic, heating leads to local swelling as polymer chains separate and create void spaces. Conversely, cooling can lead to densification as chains contract and come closer together.

There are observed polymer chain-related changes:
Crystallisation: In some semi-crystalline thermoplastics, cooling can promote crystallisation, leading to a density increase as the polymer becomes more ordered;
Chain mobility: Local heating above the glass transition temperature (Tg) results in increased chain mobility. Chains can move more freely and adopt a more disordered configuration;
Chain Entanglement: Cooling can lead to increased chain entanglement as polymer chains lose mobility and become more ordered.

An embodiment, of the composite of the invention, can have the thermal component, thermoplastic, conductor, thermal grease, and the like, in different physical states or combinations thereof.

The flexural, tensile, compressive moduli at the various temperature gradients in the thermoplastic may be determined using Dynamic Mechanical Analysis of a given combination of the thermoplastic and the thermal component in a combined embodiment. This may be used to map the stiffness of the combination of the thermal component and the thermoplastic as a function of thermal gradient/surface temperature of the thermoplastic. This is essential for building the control mechanisms, protocols, algorithms, open/closed loop systems.

$${k}_{T H} ∝ \frac{1}{{T}_{T P}}$$

Relationship between stiffness of the thermoplastic k_{TH} and it's surface temperature of the thermoplastic T_{TP}; T_{d} Surface temperature of the thermoplastic for desired stiffness k_{d}; Q_{HE}∝Q_{HT}+Q_{A} Heat rate of the thermal component;

$${Q}_{H T} ∝ \frac{{K}_{T P} Δ {T}_{H T} {A}_{T H}}{{c}_{T H}}$$

Heat transfer rate between the thermal component and the thermoplastic where the thermal contact between them is A_{TH}; Q_{A}∝A_{TP}+A_{HA} Heat dissipation due to the heat transfer from the surface area of the thermal component with the ambient environment/entity−A_{HA}; and the surface area of the thermoplastic with the ambient environment/entity−A_{TP}.

Temperature of the thermal component (T_{c}) should be such that |T_{TP}−T_{d}| is minimized

The system may be controlled primarily by:
1. Surface area/geometry: Q_{A}∝A_{TP}+A_{HA}−Heat dissipation rate due to the heat transfer from the surface of the thermal component with the ambient environment/entity−A_{HA}; and the thermoplastic with the ambient environment/entity−A_{TP};
2. Energy delivered to thermoplastic at the various links, sources and media from the primary power source to the thermal component: Total heat delivered:

$${Q}_{H E} ∝ \frac{{T}_{c}}{t} ∝ \frac{\vert {T}_{T P} - {T}_{c} \vert}{{A}_{T A}}$$

energy required for reaching T_{c} in time t; Heating rate: Q_{HE}=C_{HE}ΔT power required for the thermoplastic to reach Ta at the temperature rate of

$$Δ T = \frac{{T}_{c}}{t} ,$$

where C_{HE}=m_{HE}×c_{HE} is thermal mass of the thermal component of mass m_{HE} and heat capacity c_{HE} at the given temperature T_{TP}.
3. Degree of crystallinity: K_{TH}∝D_{cr}: Relationship between conductivity of the thermoplastic and degree of crystallinity. Characteristic heating-cooling may be used to alter the degree of crystallinity of the thermoplastic. Conversely, the thermal history of the thermoplastic may be considered for enhanced stiffness modulation/control.

While the present composite specification describes various heat transfer methods from/through a thermal component, it may be obvious to a person skilled in the art that the thermal component may use any known heat transfer mechanisms and their combinations to achieve a controlled thermal gradient in a thermoplastic for glass transition in cold environments and conversely, cool it in hot environments; allowing the thermoplastic component to exhibit a manipulated deformation, into a desired geometry upon application of force(s) or stress(es).

TECHNICAL ADVANTAGES: There are limited solutions for on-demand re-shapable materials; Thermoplastic casts, helmets, supports, splints, braces, due to their high stiffness provide higher amount of rigidity than plaster-based supports which allows the invention to have a relatively less volumetric footprint and also weigh less. Thermoplastics are immune to the effects of everyday liquids like alcohols, oils, waters, detergents, soaps, milks and carbonated waters; thus, it allows the patient to be oblivious to everyday liquid spills thus also allowing the patient to safely and comfortably observe daily hygiene; Using thermoplastic in the form of a mesh/grid decreases the amount of material and thereby the cost, to an extent where it is economically competitive with the ubiquitously used plaster and fiberglass composites; The configuration of the invention allows it to have lower net skin surface coverage than that of the relevant region it is applied upon and is therefore very comfortable for the patient's skin—it lets the skin be exposed to air and reduces the risk of dermal complications and irritations substantially; The smooth and inert inner layer eliminates the need for padded wrappings; An internal heat source is implemented in the volume of the thermoplastic mesh or (regions of the thermoplastic mesh) and is controlled by an external vector to raise the temperature of the mesh/part of the mesh to a range between the Glass Transition and the Melting points of the material in optimal time. The regions where these heat sources are implemented are essentially morphable, once the desirable temperature is attained. This thermosoftening nature of the material together allows these particular region(s) to become flexible upon the will of the personnel controlling the external vector, so as to be wrapped, applied and shaped as desired for the orthotic therapy; The mesh may be preformed and modified by the medical personnel as desired for individual cases before being used as an orthosis; The internal heat source allows the device to be removable and even reusable; The thermosoftening mechanism eliminates the use of crude tools for the orthosis application and removal process; Adjustability and the versatility of the morphable regions of the mesh reduces risk of compressive soft tissue injury, pressure sores, etc.; Ease of application-Pre-assembly and the rapid polymer re-crystallization after glass transition reduces lengthy complicated application procedures common in all encasing bandage/fiber based conventional orthopedic casting solutions and the custom fit orthosis like corrective helmet.

### Non-Limiting Exemplary Use-Cases

Solution for skin problems: The absolute coverage of affected regions under thick and hard materials such as plaster slabs, fiberglass, polymer helmets triggers skin irritation and dermal conditions like dermatitis, pressure sores and ulcers. This invention solves these problems.

Solution for high application and molding time: Plaster and fiberglass orthoses require a substantial amount of effort and time. It takes time in orders of up to tens of minutes for the conventional fiberglass and plaster-based orthoses to be applied, molded and completely cured. The job of making thermoplastic prosthetic leg attachments and orthotic callipers is also quite tedious requiring long man hours. Whereas devices like deformation correction helmets require days to be tailor made for the patient. This invention solves these problems.

Solution for high volume and footprint: Plaster slabs inherently have very high volume and weight which makes the daily functions of the patient more difficult who are already in discomfort. This invention solves these problems.

Solution for fragility: Plaster-based fracture casts are prone to breakage and also cannot retain their integrity in case of direct interaction with everyday liquids like alcohols, oils, water, detergents, soaps, milks and carbonated drinks. Fiberglass casts are also only partially resistant to water and other daily life liquids. This invention solves these problems.

Solution for high costs: Fiberglass casts that provide a certain degree of water resistance and higher strength are considerably expensive as compared to Plaster casts and not affordable to many. Repeat costs of single-use devices, devices that are not accommodative of growth. This invention solves these problems.

While the invention was developed for external orthopedic immobilization, it may be used very easily for various other applications such as customized chairs, shoes, morphable airfoils in aircraft, etc. The constructive combination of a thermoplastic with a second material acting as a respective heat source to enable on-demand thermosoftening of the thermoplastic can be easily used in various forms. This invention solves these problems.

The TECHNICAL ADVANCEMENT, of this invention, lies in providing a smart composite material which is controlled by using a controlled thermal gradient in thermoplastics using in-volume heating/cooling for creating desirable geometries for various applications not limited to medical immobilization. This invention is required for control of such material configurations.

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. A control system for smart thermoplastic composites comprising:
a thermoplastic component having a first cross-sectional profile;
a thermal component having a second cross-sectional profile and interfacing with the thermoplastic component, wherein the cross-sectional arrangement is such that the thermal component modifies the thermal nature of the thermoplastic component in either a hot-active state or a cold-active state, thereby ensuring a pliable region of deformation within the thermoplastic component by creating a controlled thermal gradient within a region or volume of interest in the thermoplastic component;
an energy source configured to enable transmission of energy between the thermal component and the thermoplastic component;
an energy sink configured to enable absorption of energy between the thermal component and the thermoplastic component; and
a controller configured to establish a controlled thermal gradient between the thermoplastic component and the thermal component such that heat flux between the energy source and the energy sink allows for a change in stiffness of the thermoplastic component, so as to achieve the pliable region of deformation within the thermoplastic component upon receipt of the transmitted energy.

2. The system of claim 1, wherein the controller is configured to establish the controlled thermal gradient by,
controlling the transmission of energy in a first chosen unidirectional manner and controlling the absorption of energy in a second chosen unidirectional manner, wherein the first chosen unidirectional manner and the second chosen unidirectional manner are never the same direction, and
controlling the transmission of energy between a viscous point of the thermoplastic component and a softening point of the thermoplastic component, wherein a temperature of the thermal component is such that the difference between the temperature of the thermoplastic component and the surface temperature of the thermoplastic component required for a desired stiffness is minimized.

3. The system of claim 1, further comprising:
a modulator configured to modulate energy vectors to achieve a controlled localised thermal differential in at least one of,
a thermal link between the energy source and the thermoplastic component,
a thermal link between the energy source and the thermal component,
a thermal link between the energy sink and the thermoplastic component,
a thermal link between the energy sink and the thermal component,
a thermal link between the thermoplastic component and the thermal component,
a thermal link between the thermoplastic component and an ambient environment, and
a thermal link between the thermal component and the ambient environment.

4. The system of claim 3, wherein the modulator to achieve the controlled localized thermal differential uses at least one of,
surface area correlative to heat dissipation rate,
total heat delivered correlated to heating rate, and
degree of crystallinity.

5. The system of claim 3, wherein the modulator includes at least one of:
a feedback control configured to modulate an external energy vector with time to control energy output,
a manual control configured such that energy input is controllable manually during operation of the thermoplastic-thermal component composite,
a feedforward control configured such that the external energy vector is controlled by a deterministic logic or programming considering a desired application in an active state and an inactive state of the thermoplastic-thermal component composite, and
a timer with timed sequences for energy input based on known thermal inertia and response times of the thermoplastic-thermal component composite system.

6. The system of claim 1, wherein the pliable region of deformation causes, thermo-softening of the smart thermoplastic composites in a cold surrounding, or thermo-hardening of the smart thermoplastic composites in hot surroundings.

7. The system of claim 1, wherein, for the thermal component acting as the energy source, the controller is configured to achieve the pliable region of deformation within the thermoplastic component by creating a controlled thermal gradient within a region or volume of interest in the thermoplastic component by maintaining a ratio of loss modulus of the thermoplastic component to storage modulus of the thermoplastic component at greater than or equal to 1.

8. The system of claim 1, wherein, for the thermal component acting as the energy sink, the control mechanism is configured to achieve the pliable region of deformation within the thermoplastic component by creating a controlled thermal gradient within a region or volume of interest in the thermoplastic component by maintaining a ratio of loss modulus of the thermoplastic component to storage modulus of the thermoplastic component at less than 1.

9. The system of claim 1, wherein the control mechanism is configured to achieve the pliable region of deformation within the thermoplastic component by creating a controlled thermal gradient within a region or volume of interest in the thermoplastic component by,
increasing a localised temperature of the thermoplastic component above its softening point but below its viscous temperature, and
maintaining ambient temperature above the softening point and maintaining the localised temperature below the softening point.

10. The system of claim 1, wherein the interfacing is selected from a group of interfacing types consisting of: thermal interfacing, physical interfacing, partial interfacing, completely ensconced interfacing with the thermoplastic component completely ensconcing the thermal component, completely ensconced interfacing with the thermal component completely ensconcing the thermoplastic component, partially ensconced interfacing with the thermoplastic component partially ensconcing the thermal component, and partially ensconced interfacing with the thermal component partially ensconcing the thermoplastic component.

11. The system of claim 1, wherein the transmission of energy and the absorption of energy are each in the form of at least one of: conduction, convection, and radiation.

12. The system of claim 1, wherein the control mechanism is selectable from a group of controls consisting of: electrical control, pressure control, volume control, chemical control, electromagnetic irradiance control, mechanical force control, magnetic field control, flow rate control, acoustic heating control, and acoustic cooling control.

13. The system of claim 1, wherein the thermoplastic component is activated in a hot-active mode of working, in that energy control, via the control mechanism, from the energy source to the energy sink is controlled such that thermoplastic temperature is less than thermoplastic viscous temperature and is greater than thermoplastic glass transition temperature.

14. The system of claim 1, wherein the thermoplastic component is activated in a hot-active mode of working, in that energy control, via the control mechanism, from the energy source to the energy sink is controlled such that temperature of the energy source is greater than or equal to temperature of the thermal component, temperature of the thermal component is greater than or equal to temperature of the thermoplastic component, and temperature of the thermoplastic component is greater than or equal to temperature of the energy sink.

15. The system of claim 1, wherein the thermoplastic component is activated in a cold-active mode of working, in that energy control, via the control mechanism, from the energy sink to the energy source is controlled such that thermoplastic temperature is greater than thermoplastic glass transition temperature and is less than thermoplastic viscous temperature.

16. The system of claim 1, wherein the thermoplastic component is activated in a cold-active mode of working, in that energy control, via the control mechanism, from the energy sink to the energy source is controlled such that temperature of the energy source is less than or equal to temperature of the thermal component, temperature of the thermal component is less than or equal to temperature of the thermoplastic component, and temperature of the thermoplastic component is less than or equal to temperature of the energy sink.

17. The system of claim 1, wherein the thermal component, being a non-thermoplastic component, is at least one of,
an internal thermal source acting on the basis of resistive heating or thermoelectric heating;
a polar compound or dielectric material that, when intercepted by electromagnetic radiation of a corresponding frequency, acts as a heat source, and
a component in thermal contact with an external heat source and the thermoplastic component, acting as a thermal conductor therebetween.

18. The system of claim 1, wherein the thermal component is a non-thermoplastic component acting as an internal thermal source.
